(19) United States
(12) Patent Application Publication
(10) Pub. No.: US 2023/0317921 A1
(43) Pub. Date: Oct. 5, 2023

(54) Bipolar Electrode and Bipolar Storage Battery

(71) Applicants: Furukawa Electric Co., Ltd., Tokyo (JP); The Furukawa Battery Co., Ltd., Yokohama (JP)

(72) Inventors: Yasuo Nakajima, Tokyo (JP); Hiroki Tanaka, Tokyo (JP); Kenichi Suyama, Tokyo (JP); Akira Tanaka, Tokyo (JP); Yoshinobu Taira, Iwaki (JP); Kenji Hirota, Iwaki (JP); Satoshi Shibata, Iwaki (JP)

(21) Appl. No.: 18/330,681

(22) Filed: Jun. 7, 2023

Related U.S. Application Data
(63) Continuation of application No. PCT/JP2021/039487, filed on Oct. 26, 2021.

(30) Foreign Application Priority Data
Dec. 10, 2020 (JP) 2020-204828
Dec. 10, 2020 (JP) 2020-204829
Feb. 10, 2021 (JP) 2021-019936

(51) Int. Cl. H01M 4/14; H01M 10/18

(52) U.S. Cl. CPC H01M 4/14; H01M 10/18; H01M 2004/029

(57) ABSTRACT

A bipolar electrode for a bipolar lead-acid battery includes a substrate (bipolar plate) in which a through hole for conduction is formed, a positive electrode bonded to one surface of the substrate with an adhesive layer, and a negative electrode bonded to another surface of the substrate with an adhesive layer. The substrate has, on each of the one surface and the other surface, a projecting portion surrounding an outer circumference of the through hole as an entry avoidance structure. The bipolar lead-acid battery includes multiple layers of the bipolar electrodes. By preventing adhesive from entering a through hole for conduction formed in a bipolar plate, the reliability of joining between a positive-electrode lead layer and a negative-electrode lead layer is improved.

### CROSS-REFERENCE TO RELATED APPLICATION(S)

This application is a continuation of PCT Application No. PCT/JP2021/039487, filed Oct. 26, 2021, the disclosure of which is incorporated herein in its entirety by reference.

### TECHNICAL FIELD

The present invention is a technology relating to a bipolar storage battery.

### BACKGROUND

For example, in a bipolar lead-acid battery, a plurality of bipolar electrodes are stacked via electrolyte layers, a positive electrode is formed on one surface of a substrate (bipolar plate), and a negative electrode is formed on the other surface in each of the plurality of bipolar electrodes.

The bipolar lead-acid battery described in JP Patent Publication No. 2004-179053 A is a bipolar lead-acid battery in which bipolar electrodes are stacked via a gel electrolyte layer, a positive active material layer is formed on one surface of a current collector, and a negative active material layer is formed on the other surface in each of the bipolar electrodes. JP Patent Publication No. 2004-179053 A mentions a bipolar battery including a double-sided adhesive member placed to surround the periphery of a single cell layer including a positive active material layer, a gel electrolyte layer, and a negative active material layer adjacently provided. The double-sided adhesive member is composed of an insulating material serving as a base material and an adhesive provided on both surfaces of the insulating material, and the double-sided adhesive member is sandwiched between two current collectors together with the single cell layer and is adhered to the two current collectors by the adhesive.

In a bipolar lead-acid battery described in Japanese Patent No. 6124894, a substrate (bipolar plate) made of a resin is attached inside a frame (rim) made of a resin having a frame shape. A positive-electrode lead layer and a negative-electrode lead layer are respectively provided on one surface and the other surface of the substrate. The positive-electrode lead layer and the negative-electrode lead layer are directly joined in a plurality of through holes formed in the substrate. That is, Japanese Patent No. 6124894 mentions a bipolar lead-acid battery in which a plurality of substrates (bipolar plates) each having a through hole for communicating one surface side and the other surface side and a plurality of cell members are alternately stacked. The cell member includes a positive electrode in which a positive active material layer is provided on a positive-electrode lead layer, a negative electrode in which a negative active material layer is provided on a negative-electrode lead layer, and an electrolyte layer interposed between the positive electrode and the negative electrode. The cell members are connected in series by immersing and joining the positive-electrode lead layer of one cell member and the negative-electrode lead layer of the other cell member in the through hole (communication hole) of the substrate.

### SUMMARY

Each of the bipolar electrodes described in JP Patent Publication No. 2004-179053 A and Japanese Patent No. 6124894 has a structure in which lead layers (pieces of lead foil) forming a positive electrode and a negative electrode are bonded individually to one surface and the other surface of a substrate by a liquid adhesive, and the liquid adhesive is hardened to entirely fix the lead layer to the surface of the substrate by means of the adhesive layer.

However, when a through hole for providing conduction between the positive electrode and the negative electrode is formed in the substrate as described in Japanese Patent No. 6124894, there is a problem that an adhesive applied to the surface of the substrate spreads along the surface of the substrate at the time of bonding the lead layer and consequently the adhesive may enter the through hole and contaminate the through hole. In particular, the adhesive more easily flows into the through hole as it attempts to obtain a sufficient bonding area and a sufficient bonding strength between the substrate and the lead foil.

Even after the lead layer is bonded to the substrate by the adhesive layer, there is a concern that the adhesive (adhesive layer) in the vicinity of the through hole will become fluid due to heat at the time of resistance welding for providing conduction between the positive electrode and the negative electrode, and the fluid adhesive will enter the through hole.

If the through hole for conduction is contaminated with the adhesive, conduction between the positive-electrode lead layer and the negative-electrode lead layer through the through hole is not possible, or the conduction area (welding area) is reduced. If such an event occurs, there is a problem that electric resistance between the positive-electrode lead layer and the negative-electrode lead layer increases.

The present invention has been made in view of the above points, and an object of the present invention is to improve reliability of joining between a positive-electrode lead layer and a negative-electrode lead layer by suppressing entry of an adhesive into a through hole (conduction region) for conduction formed in a substrate (bipolar plate).

To solve the issue, a bipolar electrode for a bipolar storage battery according to an embodiment of the present invention includes a bipolar plate in which a through hole for conduction is formed, a positive electrode is bonded to one surface of the bipolar plate by an adhesive layer, and a negative electrode is bonded to another surface of the bipolar plate by an adhesive layer. The bipolar plate has, on each of the one surface and the other surface, an entry avoidance structure configured to prevent entry of a fluid material into the through hole and formed of at least one structure of a concave structure and a convex structure.

Further, an embodiment of the present invention is a bipolar storage battery including the bipolar electrode of the above embodiment.

According to an embodiment of the present invention, flowing (entry) of the adhesive included in the adhesive layer into the through hole for conduction is prevented by an entry avoidance structure formed on the outer circumference of the through hole. As a result, according to the embodiment of the present invention, for example, an increase in electric resistance between the positive-electrode lead layer and the negative-electrode lead layer due to the entry of the adhesive into the through hole is prevented, and the reliability of joining the positive-electrode lead layer and the negative-electrode lead layer via the through hole can be improved.

Further, the adhesive layer is formed by hardening a liquid adhesive. In this configuration, when attaching the lead layer to the bipolar plate, although the adhesive is likely to enter the through hole for conduction, the entry of the adhesive into the through hole can be prevented by the entry avoidance structure.

If the adhesive enters the through hole, there is a concern that welding of the conduction portion will be disturbed and the electric resistance between the lead layers will be increased. In contrast, in embodiments of the present invention, the conduction portion formed in the through hole is not contaminated, and reliability at the time of welding the conduction portion is improved. As a result, a bipolar storage battery including the bipolar electrode of an embodiment of the present invention can achieve both long-term reliability and high energy density.

The entry avoidance structure includes, for example, a projecting portion (convex structure) surrounding the outer circumference of the through hole.

By providing the projecting portion on the outer circumference of the through hole, when fixing the lead layer (lead foil) to the surface of the bipolar plate with the adhesive layer made of an adhesive, contamination of the through hole with the applied adhesive is prevented. Even after the lead layer is bonded to the surface of the bipolar plate with the adhesive layer, although the adhesive layer in the vicinity of the through hole may become fluid and contaminate the through hole due to resistance welding for joining the positive-electrode lead layer and the negative-electrode lead layer through the through hole, the protruding projecting portion alleviates heat transfer to the adhesive layer in the vicinity of the through hole and prevents the adhesive layer in the fluid state from flowing into the through hole and contaminating the through hole.

In some implementations, the region where the projecting portion is formed is set to a region within 10 mm from the through hole, and the outer circumference of the through hole is surrounded by the projecting portion. In this configuration, the region where the projecting portion is formed can be limited. As a result, the fixing area between the bipolar plate and the lead layer can be sufficiently secured.

In some implementations, the projection height of the projecting portion is more than or equal to a thickness of the adhesive layer.

In this configuration, the height of the projecting portion is equal to or greater than the thickness of the adhesive layer, and the entry of the adhesive into the through hole can be more reliably prevented.

The projecting portion can have a height between 20 μm and 500 μm, inclusive. In this configuration, the protrusion amount of the projecting portion toward the lead layer side with respect to the adhesive layer can be suppressed while the entry of the adhesive into the through hole due to the projecting portion is prevented. As a result, the burden on the lead layer by the projecting portion can be suppressed.

In some implementations, the projecting portion is formed integrally with the bipolar plate. In this configuration, the projecting portion can be formed when producing the bipolar plate.

In other implementations, the projecting portion is a part separate from the bipolar plate and adheres to the surface of the bipolar plate. In this configuration, the projecting portion is positioned by simply performing attachment, and the projecting portion can be easily formed.

In some implementations, the projecting portion is an adhesion seal having an adhesive layer at least on a bipolar plate-side surface. In this configuration, the projecting portion is positioned by simply performing attachment with the adhesive layer, and the projecting portion can be easily formed.

In some implementations, the projecting portion is formed by a liquid gasket. In this configuration, the projecting portion is positioned by simply attaching the liquid gasket, and the projecting portion can be easily formed.

The entry avoidance structure includes, for example, a groove (concave structure) formed on the outer circumference of the through hole.

According to this implementation of the present invention, flowing (entry) of the adhesive included in the adhesive layer into the through hole for conduction is prevented by a groove formed in a bipolar plate. As a result, an increase in electric resistance between the positive-electrode lead layer and the negative-electrode lead layer due to the entry of the adhesive into the through hole is prevented, and the reliability of joining the positive-electrode lead layer and the negative-electrode lead layer via the through hole can be improved.

That is, by providing the groove on the outer circumference of the through hole, when fixing the lead layer (lead foil) to the surface of the bipolar plate with the adhesive layer made of an adhesive, the applied adhesive flows into the groove before flowing into the through hole. As a result, contamination of the through hole with the applied adhesive is prevented. Even after the lead layer is bonded to the surface of the bipolar plate with the adhesive layer, although the adhesive layer in the vicinity of the through hole may become fluid and contaminate the through hole due to resistance welding for joining the positive-electrode lead layer and the negative-electrode lead layer through the through hole, the adhesive layer in the fluid state flows into the groove before flowing into the through hole, and contamination of the through hole with the adhesive is avoided.

The groove, where present, is formed continuously around the outer circumference of the through hole. In this configuration, the adhesive going from the entire periphery to the through hole first flows into the groove, and the entry of the adhesive from the entire periphery into the through hole can be more reliably prevented.

The groove may include grooves formed discontinuously around the outer circumference of the through hole. In this configuration, a portion in which a groove is not formed is provided between grooves, and the rigidity of the bipolar plate in the portion in which the groove is provided can be set higher accordingly. Thus, the groove can be formed deep. As a result, grooves can be arranged on the entire periphery in the circumferential direction of the through hole while the capacity of the grooves is increased.

The discontinuously formed grooves may pass through the bipolar plate. In this configuration, the groove can be formed deep, and as a result the capacity of the grooves is increased. Thus, the amount of the adhesive able to flow into the groove can be set large.

The groove may have a depth of 0.3 mm or more and a width between 1 mm and 10 mm, inclusive, along a direction away from the through hole. In this configuration, the region where the groove is formed is in a limited range of 10 mm or less from the through hole. As a result, a fixing area based on the adhesive layer between the bipolar plate and the lead layer can be sufficiently secured.

Further, a projecting portion may be provided on the surface of the bipolar plate in the region. In this configuration, the projecting portion is formed together with the groove, and the movement of the adhesive to the through hole can also be prevented by the projecting portion.

The entry avoidance structure includes, for example, a bank part (convex structure) formed on the outer circumference of the through hole.

According to this implementation of the present invention, flowing (entry) of the adhesive included in the adhesive layer into the through hole for conduction is prevented by a bank part surrounding the through hole. As a result, an increase in electric resistance between the positive-electrode lead layer and the negative-electrode lead layer due to the entry of the adhesive into the through hole is prevented, and the reliability of joining the positive-electrode lead layer and the negative-electrode lead layer via the through hole can be improved.

That is, by providing the bank part on the outer circumference of the through hole, when fixing the lead layer (lead foil) to the surface of the bipolar plate with the adhesive layer made of an adhesive, contamination of the through hole with the applied adhesive is prevented.

Even after the lead layer is bonded to the surface of the bipolar plate with the adhesive layer, although the adhesive layer in the vicinity of the through hole may become fluid and contaminate the through hole due to resistance welding for joining the positive-electrode lead layer and the negative-electrode lead layer through the through hole, the bank part protruding from the surface of the substrate alleviates heat transfer to the adhesive layer in the vicinity of the through hole, and prevents the adhesive layer in the fluid state from flowing into the through hole and contaminating the through hole.

On the surface of the bipolar plate on which the bank part is placed, a recess that positions the bank part may be formed. In this configuration, the movement of the bank part in the left-right direction is regulated by the recess, and the position of the mounted bank part is regulated. As a result, the movement to the through hole side for conduction can be more reliably prevented by the mounted bank part.

The bank part may be formed of an elastic body such as a rubber material. In this configuration, when a load from the bonded lead layer (lead foil) is applied to the bank part, the load applied from the bank part to the lead layer is reduced by the elastic body being deformed, and the lead layer is hardly damaged.

The region where the bank part is mounted may be set to a region within 10 mm from the through hole, and the outer circumference of the through hole is surrounded by the bank part. In this configuration, the region where the bank part is formed can be limited. As a result, the fixing area between the bipolar plate and the lead layer can be sufficiently secured.

Further, the adhesive layer may be formed by hardening a liquid adhesive. In this configuration, when attaching the lead layer to the bipolar plate, although the adhesive is likely to enter the through hole for conduction, the entry of the adhesive into the through hole can be prevented by the bank part.

The projection height of the bank part is preferably equal to or greater than a thickness of the adhesive layer. In this configuration, the height of the bank part is equal to or greater than the thickness of the adhesive layer, and the entry of the adhesive into the through hole can be more reliably prevented.

In some implementations, the bank part has a height between 20 μm and 500 μm, inclusive. In this configuration, the projection height of the bank part to the lead layer side with respect to the adhesive layer can be suppressed while the entry of the adhesive into the through hole due to the bank part is prevented. As a result, the burden on the lead layer by the bank part can be suppressed.

The bipolar electrode of the present disclosure is suitable as a bipolar electrode for a bipolar lead-acid battery.

That is, a bipolar storage battery can include the bipolar electrode.

By this configuration, a bipolar storage battery capable of achieving both long-term reliability and high energy density can be provided.

### BRIEF DESCRIPTION OF THE DRAWINGS

FIG. 1 is a cross-sectional view illustrating a structural example of a bipolar lead-acid battery according to an embodiment based on the present invention.

FIG. 2 is a plan view illustrating a substrate (bipolar plate) according to an embodiment based on the present invention.

FIG. 3 is a cross-sectional view taken along line X-X′ of FIG. 2 illustrating an example of a joint structure of a positive-electrode lead layer and a negative-electrode lead layer via a through hole.

FIG. 4 is a cross-sectional view illustrating another example of the projecting portion.

FIG. 5 is a cross-sectional view illustrating another example of the projecting portion.

FIG. 6 is a cross-sectional view illustrating another example of the projecting portion.

FIG. 7 is a cross-sectional view illustrating another example of the projecting portion.

FIG. 8 is a cross-sectional view illustrating another example of the projecting portion.

FIG. 9 is a plan view illustrating a substrate (bipolar plate) according to an embodiment based on the present invention.

FIG. 10 is a cross-sectional view taken along line X-X′ of FIG. 9 illustrating an example of a joint structure of a positive-electrode lead layer and a negative-electrode lead layer via a through hole.

FIGS. 11A and 11B are cross-sectional views illustrating another example of a groove.

FIG. 12 is a cross-sectional view illustrating another example of a groove.

FIGS. 13A and 13B are cross-sectional views illustrating another example of a groove.

FIG. 14 is a cross-sectional view illustrating another example of a groove.

FIG. 15 is a cross-sectional view illustrating another example of a groove.

FIG. 16 is a plan view illustrating a substrate (bipolar plate) according to an embodiment based on the present invention.

FIG. 17 is a diagram illustrating an example of a relationship between a recess formed on a surface of a substrate (bipolar plate) and a bank part.

FIG. 18 is a cross-sectional view taken along line X-X′ of FIG. 16 illustrating an example of a joint structure of a positive-electrode lead layer and a negative-electrode lead layer via a through hole.

FIG. 19 is a cross-sectional view illustrating another example of a joint structure of a positive-electrode lead layer and a negative-electrode lead layer via a through hole.

FIG. 20 is a cross-sectional view illustrating another example of a joint structure of a positive-electrode lead layer and a negative-electrode lead layer via a through hole.

FIGS. 21A, 21B, and 21C are cross-sectional views illustrating another example of a bank part.

### DETAILED DESCRIPTION

Embodiments of the present invention are described with reference to the drawings.

Here, the same components are described with the same reference signs unless otherwise noted. In each drawing, the thickness and ratio of each component may be exaggerated, and the number of components may also be illustrated differently from those of the actual product. The present invention is not limited to the following embodiments as they are. Instead, the present invention can be embodied by appropriate combinations or modifications without departing from the gist of the present invention, and forms in which such changes or improvements are added can also be included in the present invention.

In the following description, a bipolar lead-acid battery is described as an example of a bipolar storage battery; however, the present disclosure is also applicable to a bipolar storage battery other than the bipolar lead-acid battery.

### First Embodiment

A first embodiment is an example in which an entry avoidance structure is configured by a projecting portion (convex structure).

Configuration

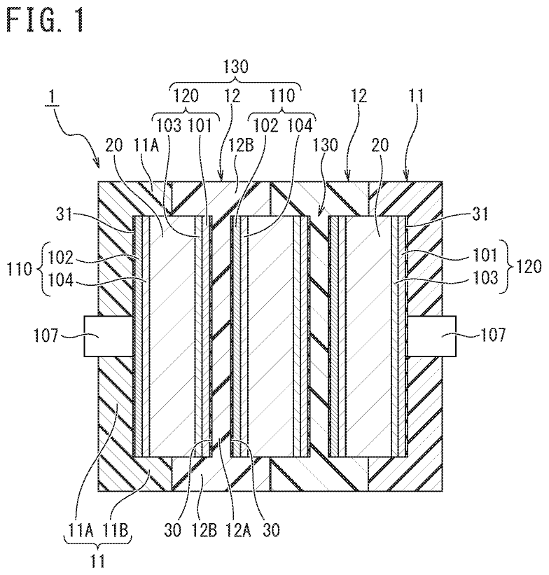

A structure of a bipolar lead-acid battery 1 of the present embodiment will now be described with reference to FIG. 1.

The bipolar lead-acid battery 1 illustrated in FIG. 1 is configured by stacking a plurality of bipolar electrodes 130 in the thickness direction via electrolyte layers 20. Electrolyte layers 20 are separately stacked on both ends in the stacking direction of the stacked bipolar electrode group. The electrolyte layer 20 placed on the left end in FIG. 1 is electrically connected to a negative electrode terminal 107 via a negative electrode 110, and the electrolyte layer 20 placed on the right end in FIG. 1 is electrically connected to a positive electrode terminal 107 via a positive electrode 120. An adhesive layer 31 is for bonding the negative electrode 110 and the positive electrode 120 on the end side in the stacking direction to a main body portion 11A (also called an end plate) of an external frame 11. The external frame 11 includes the plate-shaped main body portion 11A and a rising portion 11B (also called a rim) rising from the entire outer circumference portion of the main body portion 11A.

Here, the electrolyte layer 20, and the positive electrode 120 and the negative electrode 110 facing each other across the electrolyte layer 20, constitute one cell member. In the example of FIG. 1, a bipolar lead-acid battery 1 including two bipolar electrodes 130 and three cell members is illustrated. The number of cell members and the number of stacked bipolar electrodes 130 are set according to the required storage capacity of the bipolar lead-acid battery 1.

Bipolar Electrode 130

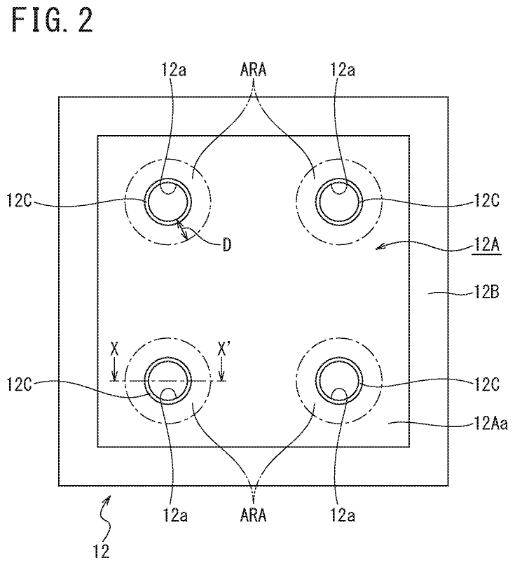

Referring to FIGS. 1 and 2, the bipolar electrode 130 includes an internal frame 12, a positive electrode 120, and a negative electrode 110.

The internal frame 12 of the present embodiment is composed of a plate-like substrate 12A (also called a bipolar plate) provided with electrodes on both surfaces and a frame member 12B (also called a rim) integrally connected to the entire outer circumference portion of the substrate 12A. The frame member 12B rises from both surfaces of the substrate 12A in the thickness direction of the substrate 12A.

The internal frame 12 and the external frame 11 are made of, for example, a thermoplastic resin. Examples of the thermoplastic resin include an acrylonitrile-butadiene-styrene copolymer (ABS) resin or polypropylene. These thermoplastic resins are excellent in moldability and in sulfuric acid resistance. Therefore, even if the electrolytic solution contacts the substrate 12A, decomposition, deterioration, corrosion, etc., hardly occur in the substrate 12A.

In the present embodiment, a case where the frame member 12B is formed integrally with the substrate 12A is given as an example; however, the substrate 12A and the frame member 12B may be configured separately.

The frame members 12B of the internal frame 12 constitute a framework of the battery 1 accommodating a plurality of bipolar electrodes 130 together with the pair of external frames 11 arranged on both end sides in the stacking direction. A space formed between adjacent internal frames 12 and a space formed between the adjacent internal frames 12 and the external frames 11 form a chamber (cell) for accommodating the cell member.

As illustrated in FIG. 1, the positive electrode 120 is bonded to one surface 12Aa of the substrate 12A by an adhesive layer 30. The positive electrode 120 includes a positive-electrode lead layer 101 and a positive active material layer 103 placed on the positive-electrode lead layer 101. The positive-electrode lead layer 101 is made of lead or a lead alloy and has, for example, a foil shape (lead foil). The positive-electrode lead layer 101 is bonded to one surface 12Aa of the substrate 12A by an adhesive.

Further, as illustrated in FIG. 1, the negative electrode 110 is bonded to another surface 12Ab of the substrate 12A by an adhesive layer 30. The negative electrode 110 includes a negative-electrode lead layer 102 and a negative active material layer 104 placed on the negative-electrode lead layer 102. The negative-electrode lead layer 102 is made of lead or a lead alloy and has, for example, a foil shape (lead foil). The negative-electrode lead layer 102 is bonded to the other surface 12Ab of the substrate 12A by an adhesive.

Here, as illustrated in FIG. 2, a plurality of through holes 12a for conduction are formed in the substrate 12A to bring the positive-electrode lead layer 101 and the negative-electrode lead layer 102 into conduction (electrically joining them). FIG. 2 illustrates, as an example, a case where the cross-sectional shape of the through hole 12a is circular; however, the cross-sectional shape of the through hole 12a is not particularly limited and may be a polygonal shape or the like.

Projecting Portion 12C

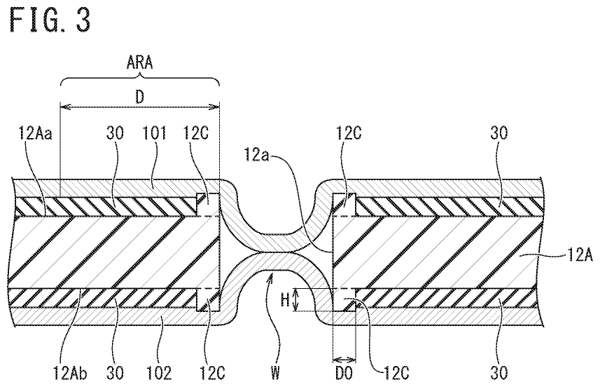

In the present embodiment, an endless annular projecting portion 12C continuously surrounding the outer circumference of the opening of each through hole 12a without interruption like that illustrated in FIGS. 2 and 3 is formed in each of one surface 12Aa and the other surface 12Ab of the substrate 12A.

The projecting portion 12C forms an entry avoidance structure configured to prevent entry of a fluid material from the outer circumference into the through hole 12a.

The shape of the endless annular projecting portion 12C does not need to be a shape concentric with the through hole 12a. The shape of the endless annular projecting portion 12C in a planar view may be a rectangular shape or the like. However, from the viewpoint of not forming a corner portion, in a planar view the shape of the projecting portion 12C is preferably a shape in which circular arcs of a circle, an ellipse, or the like are continuously connected.

The adhesive layer 30 is not formed on the projecting portion 12C.

In the present embodiment, it is assumed that the adhesive layer 30 is formed by applying a liquid adhesive to the surface of the substrate 12A excluding the projecting portion 12C. Then, the liquid adhesive is hardened to form the adhesive layer 30.

From the viewpoint of increasing the adhesion area and the adhesion strength between the surface of the substrate 12A and each of the positive-electrode lead layer 101 and the negative-electrode lead layer 102, the projecting portion 12C is, as illustrated in FIG. 2, preferably formed in a region ARA in which the distance D from the opening edge of the through hole 12a surrounding the outer circumference is 10 mm or less in a planar view. The region ARA is more preferably a region ARA within 5 mm from the opening edge.

There is a concern that the liquid adhesive applied to the surface of the substrate 12A will flow along the surface of the substrate 12A and enter the through hole 12a when bonding the positive-electrode lead layer 101 and the negative-electrode lead layer 102. In particular, as it is attempted to increase the adhesion area and the adhesion strength between the surface of the substrate 12A and each lead layer, the amount of the adhesive applied increases, and the adhesive more easily enters the through hole 12a.

In contrast, in the present embodiment, the endless annular projecting portion 12C is formed around each through hole 12a. Therefore, the adhesive flowing toward the through hole 12a is less likely to flow toward the through hole 12a side due to the step formed by the projecting portion 12C and easily flows toward other sides. Thereby, the amount of the adhesive entering the through hole 12a can reduced.

The height H of the projecting portion 12C is preferably equal to or greater than the thickness of the adhesive layer 30. For example, the height H of the projecting portion 12C is set in the range between 20 μm and 500 μm, inclusive. This is because the thickness of the adhesive layer 30 is, for example, about 20 μm to 30 μm.

By setting the height H of the projecting portion 12C to be equal to or greater than the thickness of the adhesive layer 30, the adhesive flowing toward the through hole 12a is prevented from flowing toward the through hole 12a side by the projecting portion 12C, and the adhesive can be prevented from entering the through hole 12a.

Conduction between the positive-electrode lead layer 101 and the negative-electrode lead layer 102 is executed by, for example, resistance welding, and for example, as in FIG. 3, the positive-electrode lead layer 101 and the negative-electrode lead layer 102 are electrically joined through the through hole 12a. In FIG. 3, reference sign W represents the welded portion. At the time of this welding resistance, the vicinity of the through hole 12a is heated by the welding heat; however, heating of the adhesive layer 30 in the vicinity of the through hole 12a is alleviated by the projecting portion 12C. Even if the adhesive layer 30 in the vicinity of the through hole 12a melts due to heat and takes on fluidity, in the present embodiment the adhesive having fluidity can be prevented from flowing into the through hole 12a by the endless annular projecting portion 12C.

Here, if the height H (projecting amount) of the projecting portion 12C is higher than the thickness of the adhesive layer 30, the bonded positive-electrode lead layer 101 and negative-electrode lead layer 102 may experience deformation such as bending due to the top of the projecting portion 12C, and a burden may be applied to the bonded positive-electrode lead layer 101 and negative-electrode lead layer 102. From this point of view, the height H of the projecting portion 12C is preferably, for example, 500 μm or less. More preferably, the height H of the projecting portion 12C has a difference from the height of the adhesive layer 30 of 50 μm or less, and further 20 μm or less. Usually, the thickness of the lead layer is 70 μm or more, and the difference between the height H of the projecting portion 12C and the height of the adhesive layer 30 is preferably less than the thickness of the lead layer.

The width D0 of the projecting portion 12C is, for example, set in the range between 1 mm and 10 mm, inclusive.

Considering forming the projecting portion 12C integrally with the substrate 12A by injection molding, it is estimated that the lower limit is 1 mm in width. Further, because the projecting portion 12C is formed within the range of up to 10 mm, the maximum value of the width D0 of the projecting portion 12C is 10 mm.

In FIG. 3, the surface of the through hole 12a and the inner peripheral surface of the projecting portion 12C are formed to be flush with each other; however, the present invention is not limited to this. The position of the inner peripheral surface of the projecting portion 12C may be placed in a position away from the opening edge of the through hole 12a in the outer diameter direction. Further, the position of the inner peripheral surface of the projecting portion 12C may be placed in a position on the inside of the opening edge of the through hole 12a.

Adhesive Layer

As described above, the adhesive layer 30 is formed between the substrate 12A and the positive-electrode lead layer 101, and the substrate 12A and the negative-electrode lead layer 102. The adhesive used for the adhesive layer 30 and adhesive layer 31 preferably has sulfuric acid resistance. Examples of the adhesive include an epoxy-based adhesive. The epoxy-based adhesive contains an epoxy resin as a main agent, and an acidic or basic hardening agent can be used as a hardening agent. Examples of the epoxy resin contained in the main agent include, but are not limited to, a bisphenol A type epoxy resin and a bisphenol F type epoxy resin.

Electrolyte Layer 20

The electrolyte layer 20 is made of, for example, a glass fiber mat impregnated with an electrolytic solution containing sulfuric acid.

### Modification Examples

(1) In the above description, a case where the projecting portion 12C is molded integrally with the substrate 12A by injection molding or the like is given as an example; however, the present invention is not limited to this.

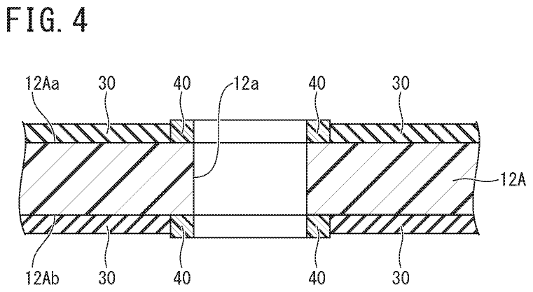

For example, as in FIG. 4, the projecting portion 40 may be configured separately from the substrate 12A, and a configuration in which the projecting portion 40 is attached to the surface of the substrate 12A to cover the entire outer circumference of the through hole 12a before the positive-electrode lead layer 101 and/or the negative-electrode lead layer 102 is bonded to the substrate 12A with an adhesive is possible.

For example, the projecting portion 40 is formed of an adhesion seal having an adhesive layer on at least one surface. Then, an adhesion seal is attached to the substrate 12A by adhesion to form the projecting portion 40.

The adhesion seal may have adhesive layers on both surfaces. In this case, the adhesion seal adheres also to the surface of the positive-electrode lead layer 101 and/or the negative-electrode lead layer 102. The adhesion seal also has a role of fixing the lead layer to the substrate 12A.

Here, the adhesion seal is composed of a base material and an adhesive layer. Examples of the base material include, but are not limited to, polyesters, polyolefins, polyimide films, and fluororesin (Teflon®) films. As a material of the adhesive layer, for example, a rubber-based, acrylic-based, or silicone-based adhesive can be used. The adhesion seal is not limited to this, and other known adhesion seals may be used.

Regarding attachment of the adhesion seal to the substrate 12A, for example, after the adhesion seal is attached to cover the through hole 12a, a portion overlapping with the through hole 12a may be hollowed out to form the projecting portion 40.

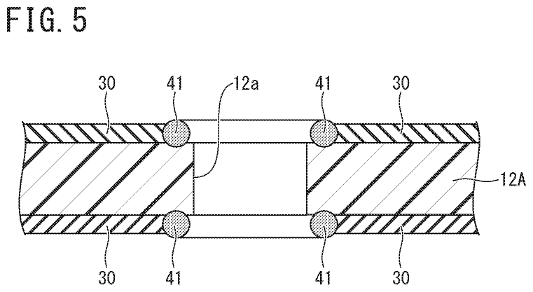

As in FIG. 5, the projecting portion 41 may also be formed by attaching a liquid gasket to the outer circumference of the through hole 12a. It is preferable to form a recess on the surface of the substrate 12A on which the liquid gasket is to be formed, in view of facilitating the placement of the liquid gasket.
(2) FIG. 3 illustrates, as an example, a case where the shape of the vertical end surface of the projecting portion 12C is rectangular; however, the present invention is not limited to this.

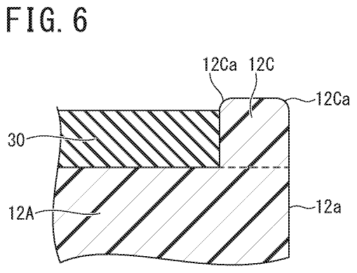

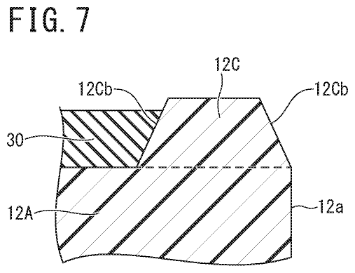

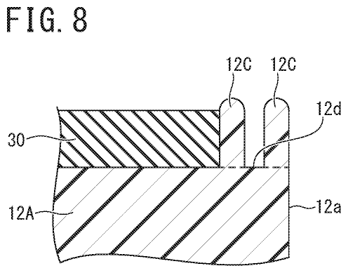

For example, as illustrated in FIG. 6, the projecting portion 12C may be rounded in an arc shape to give curvature to the corner portion 12Ca of the projecting portion 12C, or as illustrated in FIG. 7, the side surface 12Cb of the projecting portion 12C may be inclined to make the angle of the corner portion obtuse. Further, the top portion itself of the projecting portion 12C may be formed to have an arc cross section (see FIG. 8). The cross-sectional shape of the projecting portion 12C is not particularly limited.

In the case of this modification example, the burden by the projecting portion 12C on the lead layer to be bonded can be reduced.
(3) FIG. 2 illustrates, as an example, a case where one projecting portion 12C is formed; however, a plurality of projecting portions 12C may be concentrically formed as in FIG. 8. FIG. 8 illustrates, as an example, a case where two projecting portions 12C are formed. In this case, even if the adhesive flows to the through hole 12a side beyond the projecting portion 12C on the outer circumference side, the adhesive is trapped in a recess 12d between the two projecting portions 12C and is prevented from flowing into the through hole 12a side.

Here, the plurality of projecting portions 12C do not need to have similar shapes in a planar view, and the centers of the projecting portions 12C may not coincide with each other.
(4) In the above description, as in FIG. 3, a case where the positive-electrode lead layer 101 and the negative-electrode lead layer 102 are directly joined via the through hole 12a for conduction is taken as an example; however, the present invention is not limited to this. For example, a configuration in which a columnar conductor (not illustrated) is placed in the through hole 12a and the positive-electrode lead layer 101 and the negative-electrode lead layer 102 are electrically joined via the conductor is possible.

### Second Embodiment

Next, a second embodiment is described.

Configuration

A basic configuration of the second embodiment is similar to that of the first embodiment (see FIG. 1). However, the second embodiment is different from the first embodiment in terms of the entry avoidance structure provided in the bipolar plate.

Thus, a configuration related to the entry avoidance structure is described below. Other configurations are similar to those of the first embodiment, and thus a description is omitted.

In the present embodiment, a groove (concave structure) formed on the outer circumference of the through hole is included as the entry avoidance structure.

Groove Portion 212C

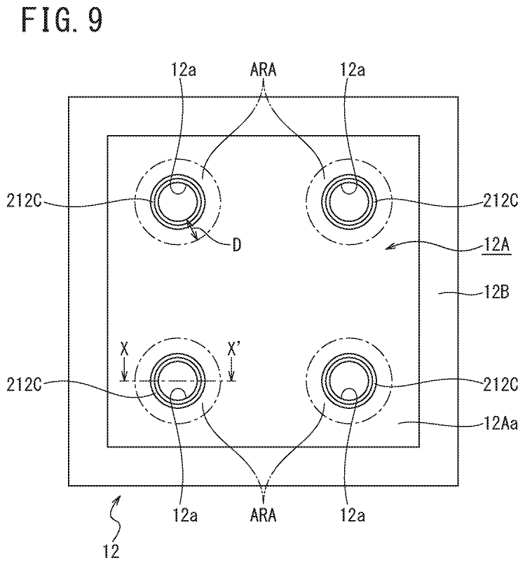

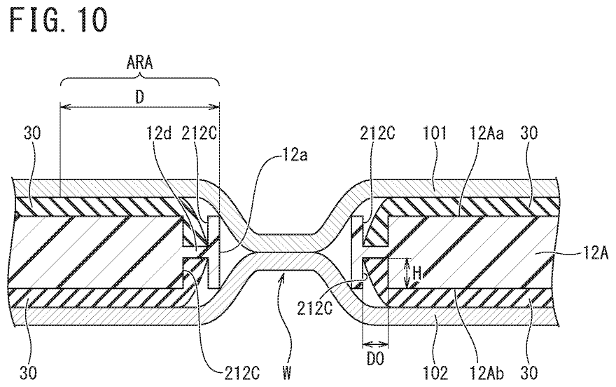

In the present embodiment, an endless annular groove portion 212C like that illustrated in FIGS. 9 and 10 continuously surrounding the outer circumference of the opening of each through hole 12a without interruption is formed on each of the one surface 12Aa and the other surface 12Ab of the substrate 12A. The shape of the endless annular groove portion 212C does not need to be a shape concentric with the through hole 12a. The shape of the endless annular groove portion 212C in a planar view may be a rectangular shape or the like. However, from the viewpoint of not forming a corner portion, in a planar view the shape of the groove portion 212C is preferably a shape in which circular arcs of a circle, an ellipse, or the like are continuously connected.

In the present embodiment, the adhesive layer 30 is assumed to form by applying a liquid adhesive to the surface of the substrate 12A. Then, the liquid adhesive is hardened to form the adhesive layer 30.

From the viewpoint of increasing the adhesion area and the adhesion strength between the surface of the substrate 12A and each of the positive-electrode lead layer 101 and the negative-electrode lead layer 102, the groove portion 212C is, as illustrated in FIG. 9, preferably formed in a region ARA in which the distance D from the opening edge of the through hole 12a surrounding the outer circumference is 10 mm or less in a planar view. The region ARA is more preferably a region ARA within 5 mm from the opening edge.

There is a concern that the liquid adhesive applied to the surface of the substrate 12A will flow along the surface of the substrate 12A and enter the through hole 12a when bonding the positive-electrode lead layer 101 and/or the negative-electrode lead layer 102. In particular, as it is attempted to increase the adhesion area and the adhesion strength between the surface of the substrate 12A and each lead layer, the amount of the adhesive applied increases, and the adhesive more easily enters the through hole 12a.

In contrast, in the present embodiment, the endless annular groove portion 212C is formed around each through hole 12a. Therefore, the adhesive flowing toward the through hole 12a flows into the groove portion 212C and is caught, and hardly flows toward the through hole 12a side. Thereby, the amount of the adhesive entering the through hole 12a can be reduced.

Conduction between the positive-electrode lead layer 101 and the negative-electrode lead layer 102 is executed by, for example, resistance welding. For example, as in FIG. 10, the positive-electrode lead layer 101 and the negative-electrode lead layer 102 are electrically joined through the through hole 12a. In FIG. 10, reference sign W represents the welded portion. At the time of this welding resistance, the vicinity of the through hole 12a is heated by the welding heat; however, heating to the adhesive layer 30 in the vicinity of the through hole 12a is alleviated by the groove portion 212C. Even if the adhesive layer 30 in the vicinity of the through hole 12a melts due to heat and takes on fluidity, in the present embodiment the adhesive having fluidity can be prevented from flowing into the through hole 12a by the endless annular groove portion 212C.

Here, the depth H (projecting amount) of the groove portion 212C is preferably 0.3 mm or more. From the viewpoint of preventing the adhesive from flowing into the through hole side, the groove portion 212C is preferably deeper. However, if the depth is too large, the thickness of the substrate is reduced, and the substrate is easily bent. Thus, it is preferable that the thickness of the substrate at the position where the groove portion 212C is formed be secured to be 1 mm or more.

For example, in the case of a configuration in which the thickness of the substrate 12A is t millimeters (mm) and the groove portions 212C are formed at the same positions on the upper and lower surfaces in a planar view as in FIG. 10, the upper limit value of the depth of the groove portion 212C is preferably set to (t−1)/2 mm.

However, for the positions of the groove portions 212C, in the case of a design in which the positions of the groove portions 212C formed on the upper and lower surfaces do not overlap in a planar view, the upper limit value of the depth of each groove portion 212C may be, for example, t−1 mm in some cases.

The width D0 of the groove portion 212C in a direction (for example, a diameter direction) along a direction away from the through hole is, for example, set in the range between 1 mm and 10 mm, inclusive.

Considering forming the groove portion 212C integrally with the substrate 12A by injection molding, it is estimated that the lower limit is 1 mm in width. Further, because the groove portion 212C is formed within the range of up to 10 mm, the maximum value of the width D0 of the groove portion 212C is 10 mm.

From the viewpoint of preventing the adhesive from flowing into the through hole, the width D0 of the groove portion 212C is preferably wider. On the other hand, if the width DO of the groove portion 212C is too wide, there is a concern that the stacked positive-electrode lead layer 101 and/or negative-electrode lead layer 102 will enter the groove and a burden due to unnecessary deformation will be applied to the positive-electrode lead layer 101 and/or the negative-electrode lead layer 102. Also, from this point of view, the maximum value of the width D0 of the groove portion 212C is set to 10 mm.

### Modification Examples

(1) In the above description, a case where the groove portion 212C has one endless annular shape is given as an example; however, the present invention is not limited to this.

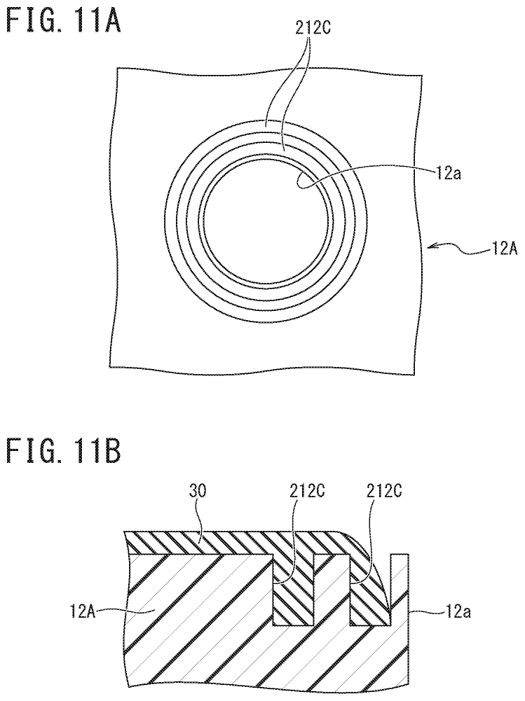

For example, as in FIGS. 11A and 11B, a plurality of groove portions 212C may be concentrically formed. FIGS. 11A and 11B illustrate, as an example, a case where two groove portions 212C are formed. In this case, even if the adhesive flows to the through hole 12a side beyond the groove portion 212C on the outer circumference side, the adhesive is trapped in the groove portion 212C on the inner side and is prevented from flowing into the through hole 12a side.

Here, the plurality of groove portions 212C do not need to have similar shapes in a planar view, and the centers of the groove portion 212C may not coincide with each other.

In this case, for example, in a case where a groove having a size of one groove portion is formed by two groove portions 212C, the width of each groove portion 212C can be relatively narrow. As a result, the amount of deformation of the bonded lead layer in the groove portion 212C is reduced, and the burden on the lead layer by the groove portion 212C is reduced.
(2) In the above description, a case where the groove portion 212C is a groove portion 212C formed in an endless annular shape continuously surrounding the outer circumference of the through hole without interruption is described; however, the configuration of the groove may be any configuration so long as it surrounds the outer circumference of the through hole and is not limited to this.

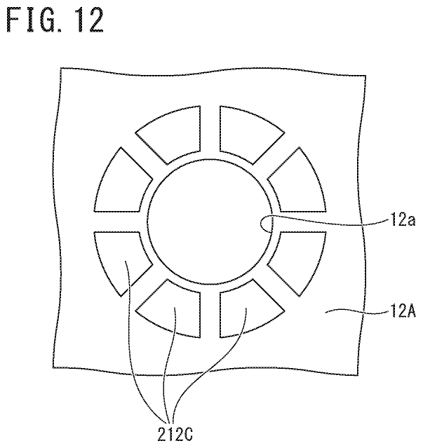

For example, the groove portion may be partially interrupted in a letter C shape or may be a groove portion 212C formed at an interval to discontinuously surround the through hole as illustrated in FIG. 12.

In this case, from the viewpoint of the burden on the lead layer by the groove portion 212C, the width in a direction along the direction away from the through hole can be set wider than that of a groove portion 212C continuously formed.

This discontinuously formed groove portion 212C may be formed to penetrate the substrate 12A.

However, the interval between groove portions 212C adjacent along the circumferential direction is preferably 1 mm or more in view of the rigidity of the substrate 12A.

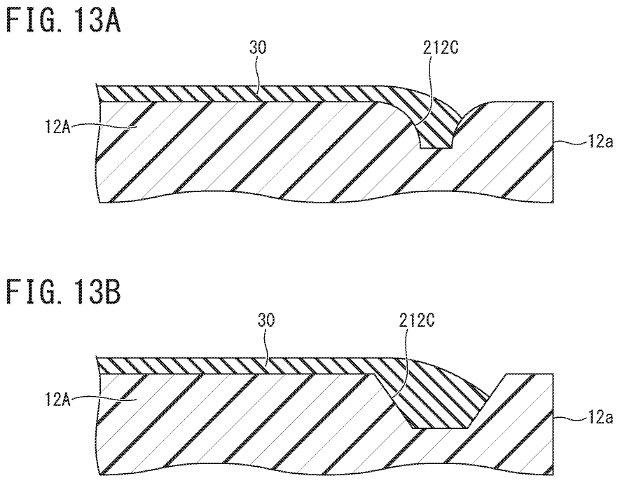

A groove portion 212C formed continuously and a groove portion 212C formed discontinuously may be used in combination.
(3) For the corner of the groove portion 212C, it is preferable that, as illustrated in FIGS. 13A and 13B, the degree of sharpness of the corner of the groove portion 212C be reduced by forming the corner in an arc shape with curvature imparted or making the angle obtuse.

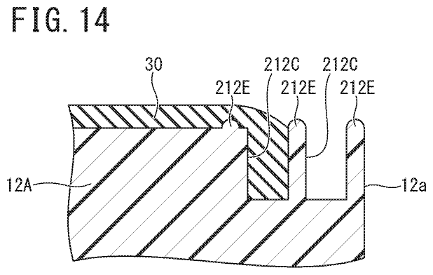

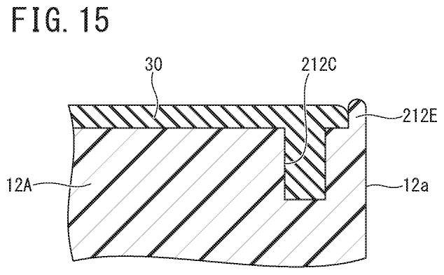

Thereby, the burden on the lead layer can be reduced more.
(4) As illustrated in FIGS. 14 and 15, a projecting portion 212E may be formed in the region ARA on the surface of the substrate, together with the groove portion 212C.

By forming the projecting portion 212E, the movement of the adhesive to the through hole 12a side can be prevented more.

FIG. 14 illustrates an example in which the projecting portion 212E is formed between groove portions 212C. FIG. 15 illustrates an example in which the projecting portion 212E is formed on the through hole 12a side. However, the relationship between the position of the projecting portion 212E and the position of the groove portion 212C is not limited to FIG. 14 or FIG. 15.

The projecting portion 212E may be formed to continuously surround the outer circumference of the through hole 12a or may be formed discontinuously along the circumferential direction.
(5) In the above description, as in FIG. 10, a case where the positive-electrode lead layer 101 and the negative-electrode lead layer 102 are directly joined via the through hole 12a for conduction is taken as an example; however, the present invention is not limited to this. For example, a configuration in which a columnar conductor (not illustrated) is placed in the through hole 12a and the positive-electrode lead layer 101 and the negative-electrode lead layer 102 are electrically joined via the conductor is possible.

### Third Embodiment

Next, a third embodiment is described.

Configuration

A basic configuration of the third embodiment is similar to that of the first embodiment (see FIG. 1). However, the third embodiment is different from the first embodiment in terms of the entry avoidance structure provided in the bipolar plate.

Thus, a configuration related to the entry avoidance structure is described below. Other configurations are similar to those of the first embodiment, and thus a description is omitted.

In the present embodiment, as the entry avoidance structure, a bank part 340 (convex structure) formed on the outer circumference of the through hole is included.

Bank Part 340

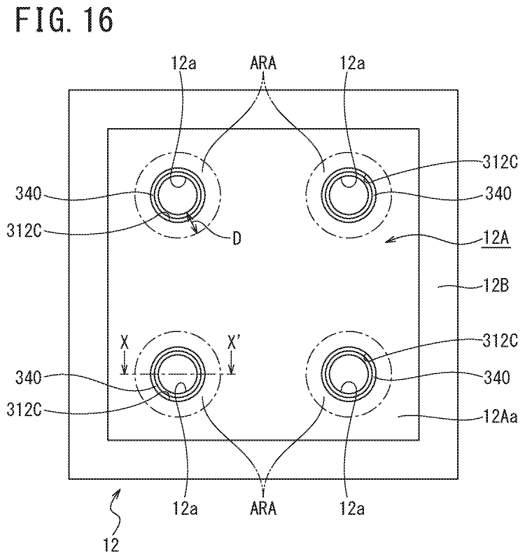

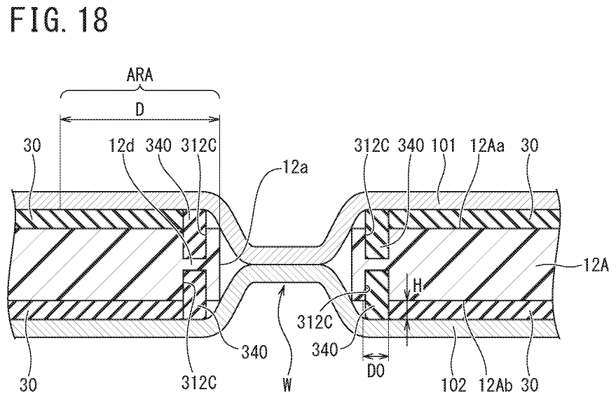

In the present embodiment, an endless annular bank part 340 continuously surrounding the outer circumference of the opening of each through hole 12a without interruption like that illustrated in FIGS. 16 and 18 is placed in each of one surface 12Aa and the other surface 12Ab of the substrate 12A and protrudes from the surface of the substrate 12A in the thickness direction of the substrate 12A. The shape of the endless annular bank part 340 does not need to be a shape concentric with the through hole 12a. The shape of the endless annular bank part 340 in a planar view may be a rectangular shape or the like. However, from the viewpoint of not forming a corner portion, in a planar view the shape of the bank part 340 is preferably a shape in which circular arcs of a circle, an ellipse, or the like are continuously connected.

The adhesive layer 30 is not formed on the bank part 340.

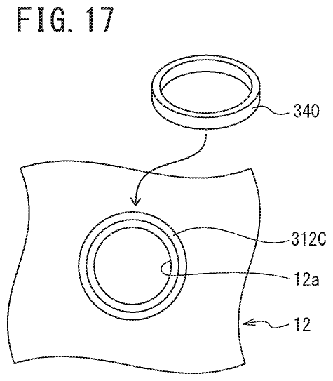

In the present embodiment, for the bank part 340, as illustrated in FIGS. 17 and 18, recesses 312C are formed on one surface 12Aa and the other surface 12Ab of the substrate 12A along the mounting position of the bank part 340. The bank part 340 is positioned by mounting the bank part 340 on the recess 312C. From the viewpoint of suppressing the movement of the bank part 340 in a direction along the surface of the substrate 12A, the recess 312C preferably has a recessed shape, the bank part 340 being able to fit into the recessed shape. The depth of the recess 312C is, for example, 5% of the thickness of the substrate 12A or 100 μm.

FIG. 18 illustrates, as an example, a case where the depth of the recess 312C is formed deeper; however, the depth of the recess 312C may be shallow. FIG. 18 illustrates an example of a case where a lower portion of the bank part 340 is mounted to be fitted into the recess 312C.

The depth of the recess 312C needs only to be set to obtain a situation where the protrusion amount (projection height H) of the bank part 340 mounted in the recess 312C from the surface of the substrate 12A is a target height.

In the present embodiment, as illustrated in FIG. 17, the shape of the recess 312C in a planar view is a ring shape matching the shape of the bank part 340; however, the shape of the recess 312C in a planar view is not limited so long as the movement of the bank part 340 in the left-right direction can be regulated. For example, a plurality of legs may be protruded downward from a lower portion of the bank part 340, and a recess 312C having a shape for inserting the leg may be formed as the recess 312C at a portion corresponding to a lower portion of the leg.

The bank part 340 is preferably formed of an elastic body, but the bank part 340 may be made of plastic, metal, or the like. The bank part 340 needs only to have rigidity enough to prevent movement of the flowing adhesive.

In a case where the bank part 340 is formed of an elastic body, for example, the bank part may be formed of a rubber material. However, it is preferable to have sulfuric acid resistance. Examples of the rubber material to form the bank part 340 include natural rubber, styrene rubber, butyl rubber, nitrile rubber, ethylene-propylene rubber, chloroprene rubber, chlorosulfonated polyethylene, silicone rubber, and fluororubber, and combinations thereof.

Also, foamed rubber may be used as the rubber material. Examples of the foamed rubber include foamed rubber obtained by foaming ethylene-propylene rubber.

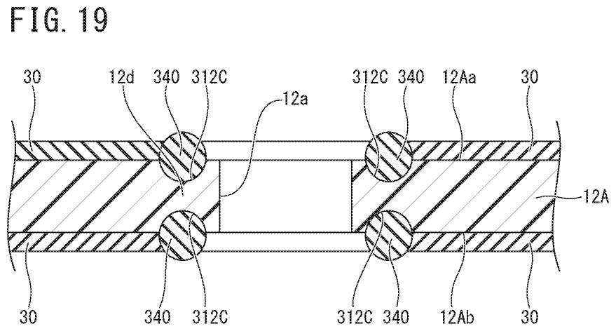

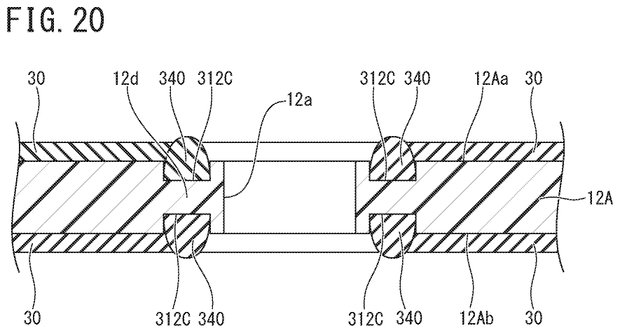

FIG. 18 illustrates, as an example, a case where the cross-sectional shape of the bank part 340 is rectangular; however, the cross-sectional shape of the bank part 340 may be another shape. The cross-sectional shape of the bank part 340 may be, for example, a circular shape like that illustrated in FIG. 19 or may be a semicircular shape like that illustrated in FIG. 20.

In a case where the bank part 340 is an elastic body, the width of the recess 312C may be slightly smaller than the width of the bank part 340, and the bank part 340 may be shrunk and fitted.

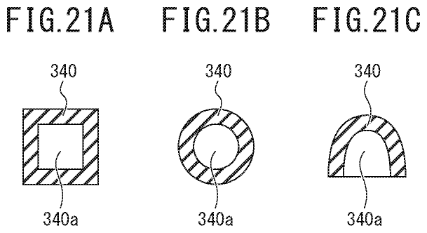

As illustrated in FIGS. 21A to 21C, a cavity 340a may be formed inside the bank part 340 to adjust the elastic force of the bank part 340.

Here, in view of the burden on the positive-electrode lead layer 101 and the negative-electrode lead layer 102 to be bonded, the bank part 340 preferably has no corner portion having an acute angle, such as an arc cross-sectional shape. However, in a case where the bank part 340 is formed of an elastic body, even if the bank part 340 has a corner portion, an excessive load burden due to the tip of the corner portion can be suppressed by the corner portion being deformed by pressing.

In the present embodiment, it is assumed that the adhesive layer 30 is formed by applying a liquid adhesive to the surface of the substrate 12A excluding the bank part 340. Then, the liquid adhesive is hardened to form the adhesive layer 30.

From the viewpoint of increasing the adhesion area and the adhesion strength between the surface of the substrate 12A and each of the positive-electrode lead layer 101 and the negative-electrode lead layer 102, the bank part 340 is, as illustrated in FIG. 16, preferably placed in a region ARA in which the distance D from the opening edge of the through hole 12a surrounding the outer circumference is 10 mm or less in a planar view. The region ARA is more preferably a region ARA within 5 mm from the opening edge of the through hole 12a.

There is a concern that the liquid adhesive applied to the surface of the substrate 12A will flow along the surface of the substrate 12A and enter the through hole 12a when bonding the positive-electrode lead layer 101 and/or the negative-electrode lead layer 102. In particular, as it is attempted to increase the adhesion area and the adhesion strength between the surface of the substrate 12A and each lead layer, the amount of the adhesive applied increases, and the adhesive more easily enters the through hole 12a.

In contrast, in the present embodiment, the endless annular bank part 340 is placed around each through hole 12a. Therefore, the adhesive flowing toward the through hole 12a is less likely to flow toward the through hole 12a side due to the step (projection) formed by the bank part 340, and the adhesive easily flows toward other sides. Thereby, the amount of the adhesive entering the through hole 12a can be reduced.

The projection height H of the bank part 340 from the surface of the substrate 12A is preferably equal to or greater than the thickness of the adhesive layer 30. For example, the projection height H of the bank part 340 is set in the range between 20 μm and 500 μm, inclusive. This is because the thickness of the adhesive layer 30 is, for example, about 20 μm to 30 μm.

By setting the projection height H of the bank part 340 to be equal to or greater than the thickness of the adhesive layer 30, the adhesive flowing toward the through hole 12a is prevented from flowing toward the through hole 12a side by the bank part 340, and the adhesive can be prevented from entering the through hole 12a.

Conduction between the positive-electrode lead layer 101 and the negative-electrode lead layer 102 is executed by, for example, resistance welding. For example, as in FIG. 18, the positive-electrode lead layer 101 and the negative-electrode lead layer 102 are electrically joined through the through hole 12a. In FIG. 18, reference sign W represents the welded portion. At the time of this welding resistance, the vicinity of the through hole 12a is heated by the welding heat; however, heating to the adhesive layer 30 in the vicinity of the through hole 12a is alleviated by the bank part 340. Even if the adhesive layer 30 in the vicinity of the through hole 12a melts due to heat and takes on fluidity, in the present embodiment the adhesive having fluidity can be prevented from flowing into the through hole 12a by the endless annular bank part 340.

Here, if the projection height H (projecting amount) of the bank part 340 is higher than the thickness of the adhesive layer 30, the bonded positive-electrode lead layer 101 and/or negative-electrode lead layer 102 may experience deformation such as bending due to the top of the bank part 340, and a burden may be applied to the bonded positive-electrode lead layer 101 and/or negative-electrode lead layer 102. From this point of view, the projection height H of the bank part 340 is preferably, for example, 500 μm or less. More preferably, the projection height H of the bank part 340 has a difference from the height of the adhesive layer 30 of 50 μm or less, and further 20 μm or less. Usually, the thickness of the lead layer is 70 μm or more, and the difference between the projection height H of the bank part 340 and the height of the adhesive layer 30 is preferably less than the thickness of the lead layer.

The width D0 of the bank part 340 is, for example, set in the range between 1 mm and 10 mm, inclusive.

### Modification Examples

(1) FIG. 16 illustrates, as an example, a case where one bank part 340 is mounted to surround the through hole 12a; however, a plurality of bank parts 340 may be concentrically mounted around the through hole 12a. In this case, even if the adhesive flows to the through hole 12a side beyond the bank part 340 on the outer circumference side, the adhesive is trapped in the recess between two bank parts 340 and is prevented from flowing into the through hole 12a side.

Here, the plurality of bank parts 340 do not need to have similar shapes in a planar view, and the centers of the bank part 340 may not coincide with each other.
(2) In the above description, as in FIG. 18, a case where the positive-electrode lead layer 101 and the negative-electrode lead layer 102 are directly joined via the through hole 12a for conduction is taken as an example; however, the present invention is not limited to this. For example, a configuration in which a columnar conductor (not illustrated) is placed in the through hole 12a and the positive-electrode lead layer 101 and the negative-electrode lead layer 102 are electrically joined via the conductor is possible.
(3) Separately from the recess 312C for positioning the bank part 340, a recess 312C on which the bank part 340 is not mounted may be formed on the surface of the substrate 12A.

Here, two or more of the entry avoidance structures described in the first to third embodiments may be appropriately combined and used.

Others

The present disclosure can also have the following configurations.
(1) A bipolar electrode for a bipolar storage battery includes a bipolar plate in which a through hole for conduction is formed, a positive electrode bonded to one surface of the bipolar plate by an adhesive layer, and a negative electrode bonded to another surface of the bipolar plate by an adhesive layer. The bipolar plate has, on each of the one surface and the other surface, an entry avoidance structure configured to prevent entry of a fluid material into the through hole and formed of at least one structure of a concave structure and a convex structure.

In this configuration, for example, by providing the entry avoidance structure on the outer circumference of the through hole, when fixing the lead layer (lead foil) to the surface of the substrate with the adhesive layer made of an adhesive, contamination of the through hole with the applied adhesive is prevented. Even after the lead layer is bonded to the surface of the substrate with the adhesive layer, the adhesive layer in the vicinity of the through hole may become fluid and contaminate the through hole due to resistance welding for joining the positive-electrode lead layer and the negative-electrode lead layer through the through hole. The entry avoidance structure alleviates heat transfer to the adhesive layer in the vicinity of the through hole and prevents the adhesive layer in the fluid state from flowing into the through hole and contaminating the through hole.

If the adhesive enters the through hole, there is a concern that welding of the conduction portion will be disturbed, and the electric resistance between the lead layers will be increased. In contrast, in the present embodiment, the conduction portion formed in the through hole is not contaminated, and reliability at the time of welding the conduction portion is improved. As a result, a bipolar storage battery including the bipolar electrode of the present embodiment can achieve both long-term reliability and high energy density.

A fixing area between the substrate and the lead layer can be sufficiently secured by a configuration in which the region where the entry avoidance structure is formed is set to a region within 10 mm from the through hole, and the outer circumference of the through hole is surrounded by the entry avoidance structure.
(2) The adhesive layer is formed by hardening a liquid adhesive. In this configuration, when attaching the lead layer to the substrate, although the adhesive is likely to enter the through hole for conduction, the entry of the adhesive into the through hole can be prevented by the projecting portion.
(3) A bipolar electrode for a bipolar storage battery includes a substrate in which a through hole for conduction is formed, a positive electrode is bonded to one surface of the substrate by an adhesive layer, and a negative electrode is bonded to another surface of the substrate by an adhesion layer. The substrate has, on each of the one surface and the other surface, a projecting portion continuously surrounding an outer circumference of the through hole without interruption.

The projecting portion is, for example, formed in a region within 10 mm from the through hole, and the outer circumference of the through hole is surrounded by the projecting portion in a planar view.

In this configuration, for example, by providing the projecting portion on the outer circumference of the through hole, when fixing the lead layer (lead foil) to the surface of the substrate with the adhesive layer made of an adhesive, contamination of the through hole with the applied adhesive is prevented. Even after the lead layer is bonded to the surface of the substrate with the adhesive layer, although the adhesive layer in the vicinity of the through hole may become fluid and contaminate the through hole due to resistance welding for joining the positive-electrode lead layer and the negative-electrode lead layer through the through hole, the projecting portion alleviates heat transfer to the adhesive layer in the vicinity of the through hole, and prevents the adhesive layer in the fluid state from flowing into the through hole 12a and contaminating the through hole 12a.

A fixing area between the substrate and the lead layer can be sufficiently secured by a configuration in which the region where the projecting portion is formed is set to a region within 10 mm from the through hole, and the outer circumference of the through hole is surrounded by the projecting portion.
(4) The projection height of the projecting portion is more than or equal to a thickness of the adhesive layer. In this configuration, the entry of the adhesive into the through hole can be more reliably prevented.
(5) The projecting portion has a height between 20 μm and 500 μm, inclusive. In this configuration, the burden on the lead layer by the projecting portion can be suppressed while preventing the entry of the adhesive into the through hole.
(6) The projecting portion is formed integrally with the bipolar plate. In this configuration, the projecting portion can be formed when producing the substrate.
(7) The projecting portion is a part separate from the substrate and adheres to the surface of the substrate. In this configuration, the projecting portion is positioned by simply performing attachment, and the projecting portion can be easily formed.
(8) The projecting portion is an adhesion seal having an adhesive layer at least on a substrate-side surface. In this configuration, the projecting portion is positioned by simply performing attachment with the adhesive layer, and the projecting portion can be easily formed.
(9) The projecting portion is formed by a liquid gasket. In this configuration, the projecting portion is positioned by simply attaching the liquid gasket, and the projecting portion can be easily formed.
(10) A bipolar electrode for a bipolar storage battery includes a substrate in which a through hole for conduction is formed, a positive electrode bonded to one surface of the substrate by an adhesive layer, and a negative electrode bonded to another surface of the substrate by an adhesive layer. The substrate has, on each of the one surface and the other surface, a groove formed on an outer circumference of the through hole. The groove is, in a planar view, formed in a region within 10 mm from an opening edge of the through hole, the groove being formed on the outer circumference of the through hole. In this configuration, for example, by providing the groove on the outer circumference of the through hole, when fixing the lead layer (lead foil) to the surface of the substrate with the adhesive layer made of an adhesive, contamination of the through hole with the applied adhesive is prevented. Even after the lead layer is bonded to the surface of the substrate 12A with the adhesive layer, although the adhesive layer in the vicinity of the through hole may become fluid and contaminate the through hole due to resistance welding for joining the positive-electrode lead layer and the negative-electrode lead layer through the through hole, the groove prevents the adhesive layer in the fluid state from flowing into the through hole and contaminating the through hole.

If the adhesive enters the through hole, there is a concern that welding of the conduction portion will be disturbed and the electric resistance between the lead layers will be increased. In contrast, in the present embodiment, the conduction portion formed in the through hole is not contaminated, and reliability at the time of welding the conduction portion is improved. As a result, a bipolar storage battery including the bipolar electrode of the present embodiment can achieve both long-term reliability and high energy density.

Further, a fixing area between the substrate and the lead layer can be sufficiently secured by a configuration in which the region where the groove is formed is set to a region within 10 mm from the through hole, and the outer circumference of the through hole is surrounded by the groove.
(11) The groove is formed continuously around the outer circumference of the through hole. In this configuration, the entry of the adhesive from the entire periphery into the through hole can be more reliably prevented.
(12) The groove includes grooves formed discontinuously around the outer circumference of the through hole. In this configuration, grooves can be arranged on the entire periphery in the circumferential direction of the through hole while the capacity of the grooves is increased.
(13) The discontinuously formed grooves pass through the substrate. In this configuration, the amount of the adhesive able to flow into the groove can be set large.
(14) The groove has a depth of 0.3 mm or more and a width between 1 mm and 10 mm, inclusive, along a direction away from the through hole. In this configuration, a predetermined amount of capacity of the groove can be secured while rigidity of the substrate is secured.
(15) Further, a projecting portion is provided on the surface of the substrate in the region. In this configuration, the projecting portion is formed together with the groove, and the movement of the adhesive to the through hole can be further prevented.
(16) The projecting portion continuously surrounds the outer circumference of the through hole. In this configuration, the flowing of the adhesive from the entire periphery of the through hole into the through hole can be suppressed by the projecting portion.
(17) A bipolar electrode for a bipolar storage battery includes a bipolar plate in which a through hole for conduction is formed, a positive electrode bonded to one surface of the bipolar plate by an adhesive layer, and a negative electrode bonded to another surface of the bipolar plate by an adhesive layer. The bipolar plate has a bank part placed on the one surface and the other surface and surrounding an outer circumference of the through hole. In this configuration, for example, by providing the bank part on the outer circumference of the through hole, when fixing the lead layer (lead foil) to the surface of the substrate with the adhesive layer made of an adhesive, contamination of the through hole with the applied adhesive is prevented. Even after the lead layer is bonded to the surface of the substrate with the adhesive layer, although the adhesive layer in the vicinity of the through hole may become fluid and contaminate the through hole due to resistance welding for joining the positive-electrode lead layer and the negative-electrode lead layer through the through hole, the bank part alleviates heat transfer to the adhesive layer in the vicinity of the through hole and prevents the adhesive layer in the fluid state from flowing into the through hole and contaminating the through hole.

If the adhesive enters the through hole, there is a concern that welding of the conduction portion will be disturbed and the electric resistance between the lead layers will be increased. In contrast, in the present embodiment, the conduction portion formed in the through hole is not contaminated, and reliability at the time of welding the conduction portion is improved. As a result, a bipolar storage battery including the bipolar electrode of the present embodiment can achieve both long-term reliability and high energy density.
(18) The bank part is, for example, formed in a region within 10 mm from the through hole, and the outer circumference of the through hole is surrounded by the bank part in a planar view.

A fixing area between the substrate and the lead layer can be sufficiently secured by a configuration in which the region where the bank part is formed is set to a region within 10 mm from the opening edge of the through hole. The outer circumference of the through hole is surrounded by the bank part.
(19) On the surface of the bipolar plate on which the bank part is placed, a recess that positions the bank part is preferably formed. In this configuration, the movement of the bank part in a direction along the surface of the substrate is regulated by simply mounting the bank part in the recess. As a result, the flowing of the adhesive into the through hole can be more reliably suppressed by the bank part by simply mounting the bank part.
(20) The bank part is preferably formed of an elastic body. The bank part is formed of, for example, a rubber material. In the case of this configuration, for a load in the thickness direction of the substrate, the load applied from the bank part to the lead layer can be reduced by the bank part being elastically deformed, and the lead layer is hardly damaged by the bank part.
(21) The adhesive layer is formed by hardening a liquid adhesive. In this configuration, when attaching the lead layer to the substrate, although the adhesive is likely to enter the through hole for conduction, the entry of the adhesive into the through hole can be prevented by the bank part.
(22) The projection height H of the bank part is equal to or greater than a thickness of the adhesive layer. In this configuration, the entry of the adhesive into the through hole can be more reliably prevented.
(23) The projection height H of the bank part has a height between 20 μm and 500 μm, inclusive. In this configuration, the burden on the lead layer by the bank part can be suppressed while preventing the entry of the adhesive into the through hole.
(24) The bipolar lead-acid battery includes multiple layers of bipolar electrodes according to the above embodiments.

A bipolar lead-acid battery capable of achieving both long-term reliability and high energy density can be provided.

Here, the entire contents of Japanese Patent Application No. 2020-204828 (filed on Dec. 10, 2020), Japanese Patent Application No. 2020-204829 (filed on Dec. 10, 2020), and Japanese Patent Application No. 2021-019936 (filed on Feb. 10, 2021), the present application claiming priority based on these applications, are incorporated into the present disclosure by reference. Although herein a description is given with reference to a limited number of embodiments, the scope of right is not limited to those, and modifications of each embodiment based on the above disclosure are self-evident to those skilled in the art.

The following is a list of reference signs used in this specification and in the drawings.
1 bipolar lead-acid battery
11 external frame
11A main body portion (end plate)
11B rising portion (rim)
12 internal frame
12A substrate (bipolar plate)
12B frame member (rim)
12C projecting portion (entry avoidance structure)
12a through hole
20 electrolyte layer
30 adhesive layer
31 adhesive layer
40 projecting portion (entry avoidance structure)
41 projecting portion (entry avoidance structure)
101 positive-electrode lead layer
102 negative-electrode lead layer
103 positive active material layer
104 negative active material layer
110 negative electrode
120 positive electrode
130 bipolar electrode
212C groove (entry avoidance structure)
212E projecting portion (entry avoidance structure)
312C recess
340 bank part (entry avoidance structure)

What is claimed is:

1. A bipolar electrode for a bipolar storage battery, the bipolar electrode comprising:
a bipolar plate in which a through hole for conduction is formed;
a positive electrode bonded to one surface of the bipolar plate by an adhesive layer; and
a negative electrode bonded to an other surface of the bipolar plate by an adhesive layer, wherein the bipolar plate has, on each of the one surface and the other surface, an entry avoidance structure configured to prevent entry of a fluid material into the through hole and formed of at least one structure of a concave structure and a convex structure.

2. The bipolar electrode according to claim 1, wherein the adhesive layer is formed by hardening a liquid adhesive.

3. The bipolar electrode according to claim 1, wherein the entry avoidance structure includes a projecting portion surrounding an outer circumference of the through hole.

4. The bipolar electrode according to claim 3, wherein the projecting portion is formed in a region within 10 mm from an opening edge of the through hole in a planar view.

5. The bipolar electrode according to claim 3, wherein a height of the projecting portion is more than or equal to a thickness of the adhesive layer.

6. The bipolar electrode according to claim 5, wherein the projecting portion has a height between 20 μm and 500 μm, inclusive.

7. The bipolar electrode according to claim 3, wherein the projecting portion is formed integrally with the bipolar plate.

8. The bipolar electrode according to claim 3, wherein the projecting portion is a part separate from the bipolar plate, and the projecting portion adheres to the surface of the bipolar plate.

9. The bipolar electrode according to claim 8, wherein the projecting portion is an adhesion seal having an adhesive layer at least on a bipolar plate-side surface.

10. The bipolar electrode according to claim 8, wherein the projecting portion is formed by a liquid gasket.

11. The bipolar electrode according to claim 1, wherein the entry avoidance structure includes a groove formed on an outer circumference of the through hole.

12. The bipolar electrode according to claim 11, wherein the groove is formed continuously around the outer circumference of the through hole.

13. The bipolar electrode according to claim 11, wherein the groove comprises grooves formed discontinuously around the outer circumference of the through hole.

14. The bipolar electrode according to claim 13, wherein the grooves pass through the bipolar plate.

15. The bipolar electrode according to claim 11, wherein the groove has a depth of 0.3 mm or more and a width between 1 mm and 10 mm, inclusive, along a direction away from the through hole.

16. The bipolar electrode according to claim 1, wherein the entry avoidance structure includes a bank part surrounding an outer circumference of the through hole.

17. The bipolar electrode according to claim 16, wherein in a planar view, the bank part is formed in a region within 10 mm from an opening edge of the through hole.

18. The bipolar electrode according to claim 16, wherein on the surface of the bipolar plate on which the bank part is placed, a recess that positions the bank part is formed.

19. The bipolar electrode according to claim 16, wherein the bank part includes an elastic body.

20. The bipolar electrode according to claim 19, wherein the bank part is made of a rubber material.

21. The bipolar electrode according to claim 16, wherein a projection height of the bank part from the surface of the bipolar plate is equal to or greater than a thickness of the adhesive layer.

22. The bipolar electrode according to claim 21, wherein the projection height of the bank part from the surface of the bipolar plate is between 20 μm and 500 μm, inclusive.

23. The bipolar electrode according to claim 1, wherein the bipolar electrode is a bipolar electrode for a bipolar lead-acid battery.

24. A bipolar storage battery comprising the bipolar electrode according to claim 1.
